(19) United States
(12) Patent Application Publication
(10) Pub. No.: US 2003/0076636 A1
(43) Pub. Date: Apr. 24, 2003

(54) On-chip ESD protection circuit with a substrate-triggered SCR device

(76) Inventors: Ming-Dou Ker, Hsin-Chu City (TW); Tung-Yang Chen, Hsin-Chu City (TW); Tien-Hao Tang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,827

(22) Filed: Oct. 23, 2001

(51) Int. Cl. H02H 9/00

(52) U.S. Cl. 361/56

(57) ABSTRACT

An ESD (electrostatic discharge) protection circuit is electrically connected to an I/O buffering pad, an internal circuit (IC), a V_{SS} power terminal and a V_{DD} power terminal. The ESD protection circuit comprises a first ESD-detection circuit electrically connected between the I/O pad and the V_{SS} power terminal, a second ESD-detection circuit electrically connected between the I/O pad and the V_{DD} power terminal, a P-STSCR comprising a first lateral SCR and a P trigger node, and an N-STSCR comprising a second lateral SCR and an N trigger node. When a positive-to-V_{SS} ESD event occurs on the I/O buffering pad, the first ESD-detection circuit generates a first trigger current to the P-trigger node of the P-STSCR to trigger the first lateral SCR. The P-STSCR is thus quickly turned on, and current incurred from the positive voltage pulse is discharged to the V_{SS} power terminal. When a negative-to-V_{DD} ESD event occurs on the I/O buffering pad, the second ESD-detection circuit generates a second trigger current to the N-trigger node of the N-STSCR to trigger the second lateral SCR. The N-STSCR is quickly turned on, and current incurred from the negative voltage pulse is discharged to the V_{DD} power terminal. In contrast to the prior method of making an on-chip ESD protection circuit, the present invention uses a substrate-triggered SCR device with a much lower switching voltage in the protection circuit, and applies the protection circuit to input ESD protection circuits, output ESD protection circuits, and power-rail ESD clamp circuits. ESD robustness of the IC product in the deep submicron CMOS processes is improved, and the total layout area of the on-chip ESD protection circuit is reduced.

### BACKGROUND OF INVENTION

1. Field of the Invention

The present invention provides an ESD (electrostatic discharge) protection circuit and a power-rail ESD clamp circuit, and especially an ESD protection circuit and a power-rail ESD clamp circuit utilizing a substrate-triggered SCR to discharge high transient currents incurred from ESD.

2. Description of the Prior Art

In order to provide effective electrostatic discharge (ESD) protection for an entire CMOS IC, on-chip ESD protection circuits must be built around the input, output and power pads of the CMOS IC. Lateral silicon controlled rectifier (SCR) devices are therefore used in input (or output) ESD protection circuits, and V_{DD}-to-V_{SS} ESD clamp circuits, to effectively protect a CMOS IC against ESD-related damage. Due to the low holding voltage (V_{hold}, about˜1V in CMOS processes) of SCR devices, the power dissipation (Power=I_{ESD}*V_{hold}) of the SCR device under ESD stress is less than that for other ESD protection devices (such as diode, MOS, BJT, or field-oxide devices) in CMOS technology. Therefore, SCR devices can sustain a much higher ESD level within a smaller layout area in a CMOS IC, and lateral SCR (LSCR) devices are designed into input (or output) ESD protection circuits and power-rail ESD clamp circuits so as to protect the CMOS ICs from ESD-related damage.

However, the SCR devices often have a higher trigger voltage (30˜50V) in submicron CMOS technology, which is generally greater than the gate-oxide breakdown voltage (15˜20V) of the input stages. The SCR devices thus must be designed in conjunction with secondary protection circuits to perform the overall ESD protection function.

A lateral silicon controlled rectifier (LSCR) device for use in an ESD protection circuit is disclosed in U.S. Pat. No. 4,896,243, U.S. Pat. No. 5,012,317, and U.S. Pat. No. 5,336,908. Please refer to FIG. 1. FIG. 1 is a schematic diagram of a LSCR device 13 used in an input ESD protection circuit 10 according to the prior art. In FIG. 1, the ESD protection circuit 10 comprises an input pad 11, an internal circuit 12, and a LSCR device 13 electrically connected between the input pad 11 and the internal circuit 12. The LSCR device 13 comprises a P⁺ region 14, an N-well 15, a P-type substrate 16 and an N⁺ region 17. The LSCR device 13 is turned on by a junction breakdown mechanism between the N-well 15 and the P-type substrate 16 in the LSCR device 13 structure. The LSCR device 13 has a high trigger voltage of about ˜35V in a typical 0.35 μm CMOS process, which is generally greater than the gate-oxide breakdown voltage of the input stage in submicron CMOS IC's. The LSCR device 13 must thus work in conjunction with the secondary protection circuit 20. The secondary protection circuit 20 comprises a series resistor 21 and a gate-grounded NMOS 22 to perform the overall ESD protection function to trigger on the LSCR device 13 and protect the input stage.

In order to reduce the trigger voltage of the lateral SCR, the modified lateral SCR (MLSCR) was invented and used in ESD protection circuits. The MLSCR design is disclosed in U.S. Pat. No. 4,939,616, U.S. Pat. No. 5,343,053 and U.S. Pat. No. 5,430,595. Please refer to FIG. 2. FIG. 2 is a schematic diagram of a MLSCR device 33 used in an input ESD protection circuit 30 according to the prior art. In FIG. 2, the ESD protection circuit 30 comprises an input pad 31, an internal circuit 32, a MLSCR device 33 electrically connected between the input pad 31 and the internal circuit 32. The MLSCR device 33 comprises a P⁺ region 34, an N-well 35, a P-type substrate 36, an N⁺ region 37, and an N⁺ diffusion region 38 added across the N-well 35 and the P-type substrate 36. The MLSCR device 33 is turned on by a junction breakdown mechanism between the N⁺ diffusion region 38 and the P-type substrate 36 in the MLSCR device 33 structure. Since the breakdown voltage of the N⁺ diffusion region 38 and the P-type substrate 36 junction in the MLSCR device 33 structure is lower than the breakdown voltage of the N-well 15 and the P-type substrate 16 junction in the LSCR device 13, the MLSCR device 33 has a lower trigger voltage than the LSCR device 13. To provide greater protection to the gates of the input circuit, the MLSCR device 33 continues to work together with a secondary protection circuit 40, which comprises a series resistor 41 and a gate-grounded NMOS 42, to perform the overall ESD protection function for the input stages. With a lower trigger voltage (˜10V in a typical 0.35 μm CMOS process) of the MLSCR device 33, the secondary protection circuit 40 may have smaller device dimensions to save total layout area when compared with the secondary protection circuit 20 working in conjunction with the LSCR device 13.

In order to protect both the input stages and the output buffers in submicron CMOS IC's, a low-voltage-trigger SCR (LVTSCR) device has been invented having a much lower trigger voltage. The LVTSCR design is disclosed in U.S. Pat. No. 5,465,189, and U.S. Pat. No. 5,576,557. Please refer to FIG. 3. FIG. 3 is a schematic diagram of a LVTSCR device 60 used in an output ESD protection circuit 50 according to the prior art. In FIG. 3, the ESD protection circuit 50 comprises an output pad 51, an internal circuit 52, and a LSCR device 53 electrically connected between the output pad 51 and the internal circuit 52. The LSCR device 53 comprises a P⁺ region 54, an N-well 55, a P-type substrate 56, and an N⁺ region 57. A short-channel NMOS device 58 is inserted into the LSCR device 53 structure. The LSCR device 53 with the short-channel NMOS device 58 forms a LVTSCR device 60. The trigger voltage of the LVTSCR device 60 is equivalent to the snapback-trigger voltage of the short-channel NMOS device 58. Such an LVTSCR device 60 is turned on by a short-channel NMOS device 58 breakdown mechanism in the SCR device structure. The trigger voltage of the LVTSCR 60 in 0.35 μm CMOS technology is about 8V. With such a low trigger voltage, the LVTSCR device 60 can provide effective ESD protection for the input stages or the output buffers of CMOS IC's without requiring the use of a secondary protection circuit.

In order to protect the thinner gate oxide in very deep submicron CMOS IC's, the gate-coupled technique is applied in ESD protection circuits to further reduce the trigger voltage of the LVTSCR device. In U.S. Pat. No. 5,400,202 and U.S. Pat. No. 5,528,188, the gate-coupled LVTSCR device is disclosed. Please refer to FIG. 4. FIG. 4 is a schematic diagram of a gate-coupled LVTSCR device 80 used in an input/output ESD protection circuit 70 according to the prior art. As shown in FIG. 4, the input/output ESD protection circuit 70 comprises an I/O pad 71, an internal circuit 72, and an LSCR device 73 electrically connected between the I/O pad 71 and the internal circuit 72. The LSCR device 73 comprises a P⁺ region 74, an N-well 75, a P-type substrate 76 and an N⁺ region 77. A short-channel NMOS device 78 is inserted into the LSCR device 73 structure. The short-channel NMOS device 78 and the LSCR device 73 together form the gate-coupled LVTSCR device 80. Since a voltage is coupled to the gate 79 of the short-channel NMOS device 78 with capacitor 81 and resistor 82, the trigger voltage of the gate-coupled LVTSCR device 80 is lower than that of the other prior art devices. Such a low trigger voltage of the LVTSCR device 80 offers better protection for the thinner gate-oxides.

However, the above-mentioned on-chip ESD protection circuit using conventional SCR devices all have some disadvantages, and this fact forces limitations when they are used in advanced CMOS IC technology. It is therefore very important to develop an on-chip ESD protection circuit using a new SCR device for input ESD protection circuits, output ESD protection circuits, and power-rail ESD clamp circuits. Such a design should improve the ESD robustness of low switching voltage devices of deep submicron CMOS processes, reduce the total layout area, improve the turn-on speed to discharge ESD current quickly, and avoid heat dissipation problems.

### SUMMARY OF INVENTION

It is therefore a primary objective of the present invention to provide an ESD (electrostatic discharge) protection circuit and a power-rail ESD clamp circuit using a substrate-triggered SCR (STSCR) device, the STSCR device triggering quickly under ESD events to discharge ESD current.

In the preferred embodiment of the present invention, an ESD (electrostatic discharge) protection circuit is electrically connected to an I/O buffering pad, an internal circuit (IC), a V_{SS} power terminal, and a V_{DD} power terminal. The ESD protection circuit comprises a first ESD-detection circuit electrically connected between the I/O buffering pad and the V_{SS} power terminal, a P-type substrate-triggered silicon controlled rectifier (P-STSCR), a second ESD-detection circuit electrically connected between the I/O buffering pad and the V_{DD} power terminal, and an N-type substrate-triggered silicon controlled rectifier (N-STSCR). The P-STSCR comprises a first lateral SCR and a P trigger node. The anode and the cathode of the P-STSCR are electrically connected to the I/O buffering pad and the V_{SS} power terminal, respectively. The N-STSCR comprises a second lateral SCR and an N trigger node. The anode and the cathode of the N-STSCR are electrically connected to the V_{DD} power terminal and the I/O buffering pad, respectively.

It is an advantage of the present invention that the substrate-triggered SCR device has a very low switching voltage, and can be used in an input ESD protection circuit, an output ESD protection circuit, and a power-rail ESD clamp circuit. Therefore, the ESD robustness of the IC product in deep submicron CMOS processes is significantly improved. The ESD protection circuit uses a substrate-triggered SCR, which has the following advantages: savings to the total layout area, improved turn-on speed, quick discharging of ESD current, and avoidance of overheating problems.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a LSCR device used in an input ESD protection circuit according to the prior art.

FIG. 2 is a schematic diagram of a MLSCR device used in an input ESD protection circuit according to the prior art.

FIG. 3 is a schematic diagram of a LVTSCR device used in an output ESD protection circuit according to the prior art.

FIG. 4 is a schematic diagram of a gate-coupled LVTSCR device used in an input/output ESD protection circuit according to the prior art.

FIG. 5 is a schematic diagram of the basic concept using a P-STSCR device in an ESD protection circuit for an I/O pad according to the present invention.

FIG. 6 is a schematic diagram of using a P-STSCR device in an ESD protection circuit for an I/O pad according to the present invention.

FIG. 7 is a schematic diagram of using a P-STSCR device in a modified ESD protection circuit design for an I/O pad according to the present invention.

FIG. 8 is a schematic diagram of the basic concept of using a complementary P-STSCR device and N-STSCR device in an ESD protection circuit for an I/O pad according to the present invention.

FIG. 9 is a schematic diagram of using a P-STSCR device and an N-STSCR device in an ESD protection circuit for an I/O pad according to the present invention.

FIG. 10 is a schematic diagram of using a P-STSCR device and an N-STSCR device in a modified ESD protection circuit design for an I/O pad according to the present invention.

FIG. 11 is a schematic diagram of using a P-STSCR device and an N-STSCR device in a modified ESD protection circuit design for an I/O pad according to the present invention.

FIG. 12 is a schematic diagram of using a P-STSCR device and an N-STSCR device in an ESD protection circuit design for an I/O pad according to the present invention.

FIG. 13 is a schematic diagram of using a P-STSCR device and an N-STSCR device in an ESD protection circuit design for an I/O pad according to the present invention.

FIG. 14 is a schematic diagram of using a P-STSCR device and an N-STSCR device in an ESD protection circuit design for an I/O pad according to the present invention.

FIG. 15 is a schematic diagram of the basic concept of using stacked P-STSCR and stacked N-STSCR devices in an ESD protection circuit design for an I/O pad according to a second embodiment of the present invention.

FIG. 16 is a schematic diagram of using stacked diodes in the ESD protection circuit design for an I/O pad according to the second embodiment of the present invention.

FIG. 17 is a schematic diagram of using stacked P-STSCR, stacked N-STSCR and stacked diodes in an ESD protection circuit design for an I/O pad according to the second embodiment of the present invention.

FIG. 18 is a schematic diagram of using a P-STSCR with stacked diodes as an ESD clamp device between V_{SS} and V_{DD} power rails according to the third embodiment of present invention.

FIG. 19 is a schematic diagram of using an N-STSCR with stacked diodes as an ESD clamp device between V_{SS} and V_{DD} power rails according to the third embodiment of the present invention.

FIG. 20 is a schematic diagram of using stacked P-STSCR devices in the power-rail ESD clamp circuit according to the third embodiment of present invention.

FIG. 21 is a schematic diagram of using stacked N-STSCR devices in a power-rail ESD clamp circuit according to the third embodiment of present invention.

FIG. 22 is a schematic diagram of using stacked P-STSCR and stacked N-STSCR devices in a power-rail ESD clamp circuit according to the third embodiment of present invention.

FIG. 23 is a schematic diagram of a combined design using the stacked P-STSCR and the stacked N-STSCR devices, and diodes in a power-rail ESD clamp circuit according to the third embodiment of present invention.

FIG. 24 is a schematic diagram of using double-triggered SCR (DT-STR) devices in a power-rail ESD clamp circuit according to the third embodiment of present invention.

FIG. 25 is a schematic diagram of using a DT-SCR device and diodes in a power-rail ESD clamp circuit according to the third embodiment of present invention.

FIG. 26 to FIG. 30 are schematic diagrams of an ESD-detection circuit used to control the turning-on and turning-off of a stacked configuration between V_{DD} and V_{SS} power rails according to the present invention.

FIG. 31 and FIG. 32 are schematic diagrams of using a present invention device in a power-rail ESD clamp circuit with different V_{DD} power supplies.

FIG. 33 to FIG. 35 are schematic diagrams of using a present invention device in a power-rail ESD clamp circuit with different V_{DD} and V_{SS} power rails.

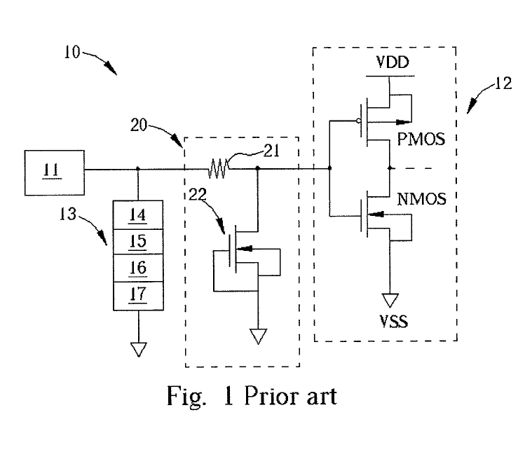

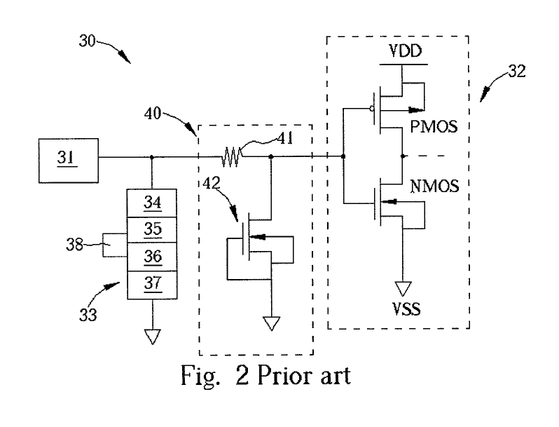

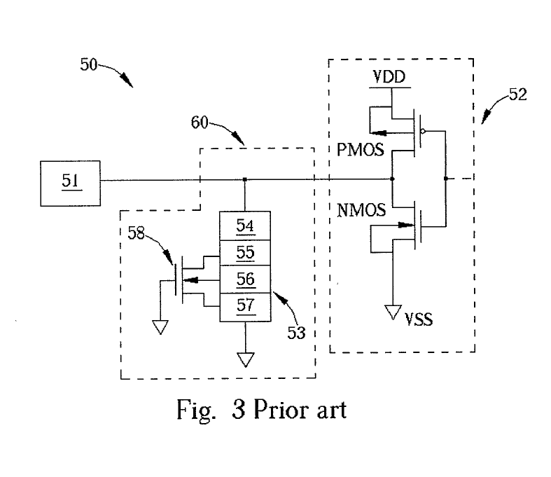

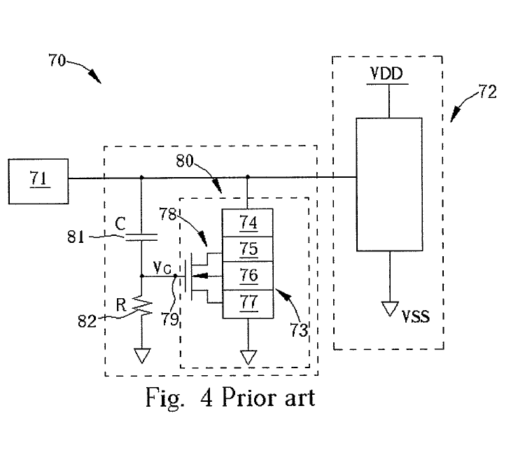

### DETAILED DESCRIPTION

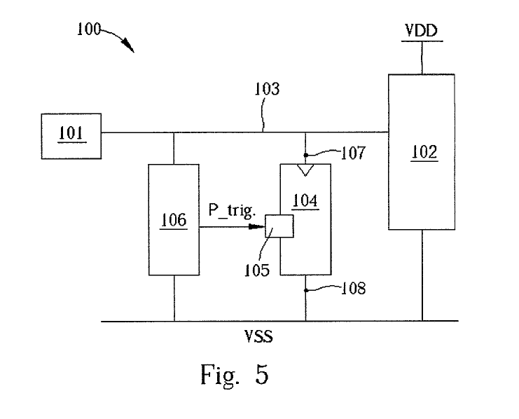

Please refer to FIG. 5. FIG. 5 is a schematic diagram of the basic concept of using a P-STSCR device 104 in an ESD protection circuit 100 for an I/O pad according to the present invention. For an input or output pad, an ESD event that often has a low ESD level is the positive-to-V_{SS} ESD event. In this positive-to-V_{SS} ESD event, the V_{SS} pin of the IC is relatively grounded, the V_{DD} pin is floating, and the positive ESD voltage is applied to the input or output pin. As shown in FIG. 5, the ESD protection circuit 100 comprises an I/O pad 101 and an internal circuit 102, and a conductor 103 electrically connected between the I/O pad 101 and the internal circuit 102. The internal circuit 102 is electrically connected between a V_{SS} power terminal and a V_{DD} power terminal. The P-trigger node 105 of a P-STSCR device 104 is electrically connected to an ESD-detection circuit 106. The anode 107 and the cathode 108 of the P-STSCR device 104 are electrically connected to the I/O pad 101 and the V_{SS} power terminal, respectively. The P-STSCR 104 comprises a P-type substrate, an N-well in the P-type substrate, a first N⁺ region, and a first P⁺ region in the P-type substrate for use as the cathode of the P-STSCR device 104. A second N⁺ region and a second P⁺ region in the N-well are used as the anode of the P-STSCR device 104. A P-trigger node 105 is located across the N-well and the P-type substrate or in the P-type substrate for accepting a trigger current (I_{trig}) to quickly turn on the P-STSCR 104. The second P⁺ region, the N-well, the P-type substrate and the first N⁺ region form a lateral SCR. Therefore, when a current flows into the P-type substrate through the P trigger node 105, the lateral SCR is triggered into its latch state, and so a low resistance path is provided and the ESD current is conducted from the anode of the P-STSCR device 104 to the cathode of the P-STSCR device 104.

When a positive-to-V_{SS} ESD event occurs on the I/O pad 101, the ESD-detection circuit 106 generates a trigger current to the P-trigger node 105 of the P-STSCR device 104 to turn on the P-STSCR device 104. Therefore, ESD current is discharged through the turned-on P-STSCR device 104 from the I/O pad 101 to the V_{SS} power terminal.

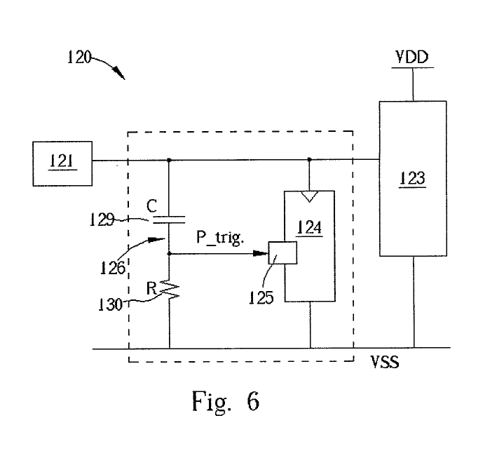

Please refer to FIG. 6. FIG. 6 is a schematic diagram of using a P-STSCR device 124 in an ESD protection circuit 120 for an I/0 pad 121 according to the present invention. The ESD-detection 126 circuit is formed by a capacitor (C) 129 and a resistor (R) 130. When a positive-to-V_{SS} ESD event occurs on the I/O pad 121, the positive transient voltage on the I/0 pad 121 is coupled through the capacitor 129 to the P-trigger node 125 of the P-STSCR device 124. The coupled voltage to the P-trigger node 125 of the P-STSCR device 124 is held for a longer time by resistor 130, which is connected between the capacitor 129 and the V_{SS} power terminal. The transient current from the capacitor 129 triggers on the P-STSCR device 124 to discharge the ESD current from the I/O pad 121 to the V_{SS} power terminal.

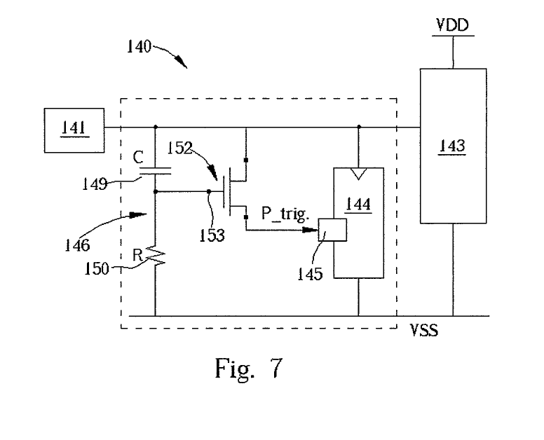

Please refer to FIG. 7. FIG. 7 is a schematic diagram of using a P-STSCR device 144 in a modified ESD protection circuit design 140 for an I/O pad 141 according to the present invention. As shown in FIG. 7, an additional NMOS transistor (Mn1) 152 is added into the ESD-detection circuit 146. When a positive-to-V_{SS} ESD event occurs on the I/O pad 141, the positive transient voltage on the I/O pad 141 is coupled through the capacitor 149 to the gate 153 of Mn1 152. The Mn1 152 with a positive coupled gate bias is turned on to conduct ESD current from the I/O pad 141 into the P-trigger node 145 of the P-STSCR device 144. Therefore, the P-STSCR device 144 is triggered on to discharge the ESD current from the I/O pad 141 to the V_{SS} power terminal, rather than flowing into an internal circuit 143.

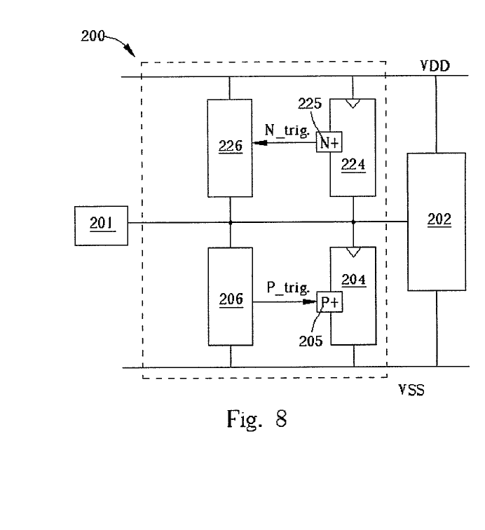

For the input or output pad, another ESD event that has a low ESD level is the negative-to-V_{DD} ESD event. In this case, the V_{DD} pin of the IC is relatively grounded, the V_{SS} pin is floating, and the negative ESD voltage is applied to an input or output pin. To provide a high ESD level for the input or output pad under both the positive-to-V_{SS} and negative-to-V_{DD} ESD events, a design concept of complementary P-STSCR and N-STSCR devices is proposed. Please refer to FIG. 8. FIG. 8 is a schematic diagram of the basic concept for using a complementary P-STSCR device 204 and an N-STSCR device 224 in an ESD protection circuit 200 for an I/O pad 201 according to the present invention. Similar to the P-STSCR device 104, the N-STSCR device 224 comprises a P-type substrate, an N-well in the P-type substrate, a first N⁺ region, and a first P⁺ region in the P-type substrate for use as the cathode of the N-STSCR device 224. A second N⁺ region and a second P region in the N-well are used as the anode of the N-STSCR device 224. An N-trigger node 225 is located across the N-well and the P-type substrate or in the N-well for quickly turning on the N-STSCR 224. The second P⁺ region, the N-well, the P-type substrate and the first N⁺ region form a lateral SCR. As shown in FIG. 8, the ESD protection circuit 200 comprises an I/O pad 201 and an internal circuit 202. The internal circuit 202 is electrically connected between a V_{SS} power terminal and a V_{DD} power terminal, and the internal circuit 202 is electrically connected to the I/O pad 201. A P-STSCR device 204 is electrically connected between the I/O pad 201 and the V_{SS} power terminal, and an N-STSCR device 224 is electrically connected between the V_{DD} power terminal and the I/O pad 201. The ESD protection circuit 200 further comprises an ESD-detection circuit 206 electrically connected between the I/O pad 201 and the V_{SS} power terminal, and another ESD-detection circuit 226 electrically connected between the I/O pad 201 and the V_{DD} power terminal. In positive-to-V_{SS} ESD events, the P-STSCR device 204 is triggered on through the P-trigger node 205 to discharge ESD current from the I/O pad 201 to the grounded V_{SS} power terminal. In negative-to-V_{DD} events, the N-STSCR device 224 is triggered on through the N-trigger node 225 to discharge negative ESD current from the I/O pad 201 to the grounded V_{DD} power terminal.

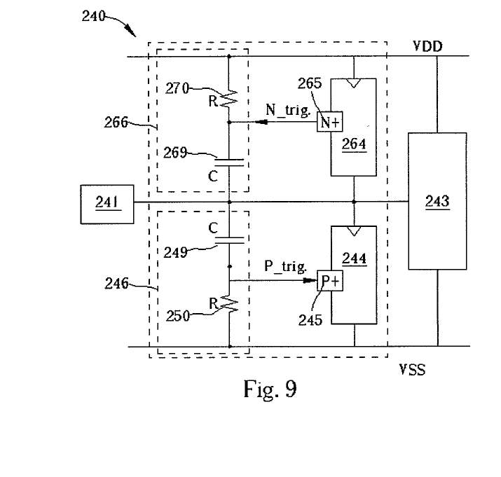

In order to realize a circuit that meets such a desired operating functionality, some of the following ESD-detection circuit designs are proposed. Please refer to FIG. 9. FIG. 9 is a schematic diagram of using a P-STSCR device 244 and an N-STSCR device 264 in an ESD protection circuit 240 for an I/O pad 241 according to the present invention. In FIG. 9, the ESD-detection circuit 246 is composed of a capacitor (C) 249 and a resistor (R) 250, and the ESD-detection circuit 266 is also composed of a capacitor (C) 269 and a resistor (R) 270. In positive-to-V_{SS} ESD events, the voltage on the I/O pad 241 is coupled through the capacitor 249 to the P-trigger node 245 of the P-STSCR device 244. The coupled voltage to the P-trigger node 245 of the P-STSCR device 244 is sustained by resistor which is electrically connected between the capacitor 249 and the V_{SS} power terminal. The transient current from the capacitor 249 triggers on the P-STSCR device 244 to discharge ESD current from the I/O pad 241 to the V_{SS} power terminal, and thus the ESD current doesn't flow into an internal circuit 243. In negative-to-V_{DD} ESD events, the voltage on the I/O pad 241 is coupled through the capacitor 269 to the N-trigger node 265 of the N-STSCR device 264. The coupled voltage to the N-trigger node 265 of the N-STSCR device 264 is sustained by resistor 270, which is connected between the capacitor 269 and the V_{DD} power terminal. The transient current from the capacitor 269 triggers on the N-STSCR device 264 to discharge ESD current from the I/O pad 241 to the grounded V_{DD} power terminal.

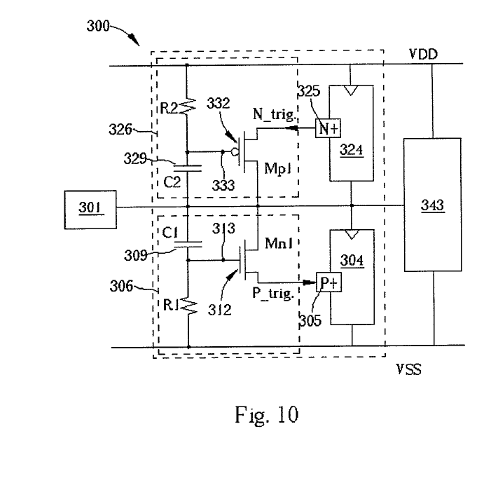

Please refer to FIG. 10. FIG. 10 is a schematic diagram of using a P-STSCR device 304 and an N-STSCR device 324 in a modified ESD protection circuit 300 for an I/O pad 301 according to the present invention. As shown in FIG. 10, an additional NMOS transistor (Mn1) 312 is added into the ESD-detection circuit 306, and an additional PMOS transistor (Mp1) 332 is added into the ESD-detection circuit 326 to enhance the trigger current. Therefore, the P-STSCR device 304 and the N-STSCR device 324 are triggered on more quickly to discharge ESD current. In negative-to-V_{DD} ESD events, the negative ESD voltage is coupled to the gate 333 of Mp1 332 through the capacitor 329. With a negative coupled voltage to bias the gate 333 of Mp1 332, Mp1 332 is turned on to conduct some negative ESD current from the I/O pad 301 to the N-trigger node 325 of the N-STSCR device 324. Therefore, the N-STSCR device 324 is triggered on by a negative trigger current in the n-well (not shown) of the N-STSCR device 324 structure to discharge the negative ESD current from the I/O pad 301 to the relatively grounded V_{DD} power terminal and so protect the internal circuit 343.

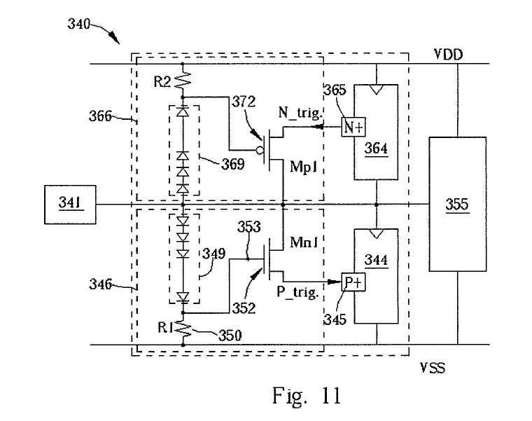

Please refer to FIG. 11. FIG. 11 is a schematic diagram of using a P-STSCR device 344 and an N-STSCR device 364 in a modified ESD protection circuit 340 for an I/O pad 341 according to the present invention. As shown in FIG. 11, capacitors 309,329 in the ESD-detection circuits 306, 326 in FIG. 10 are replaced with diode strings 349,369 for detecting an overstress ESD voltage. In positive-to-V_{SS} ESD events, the overstress ESD voltage is conducted to the gate 353 of Mn1 352 by the diode string 349. With a positive bias voltage at the gate 353 of Mn1 352, the Mn1 352 is turned on to conduct some ESD current from the I/O pad 341 into the P-trigger node 345 of the P-STSCR device 344, and therefore the P-STSCR device 344 is triggered on to discharge the ESD current from the I/O pad 341 to the V_{SS} power terminal and so protect the internal circuit 355. A similar but reverse circuit operation is also applied in turning on Mp1 372 and discharging negative ESD current from the I/O pad 341 to the grounded V_{DD} power terminal, which operates in a manner analogous to positive-to-V_{SS} ESD events. The number of diodes used in the diode string 349 is dependent on the voltage level of the normal input or output signal. In normal operating conditions, the input or output signals on the I/O pad 341 do not cause a voltage across the resistor 350 that is greater than the NMOS Mn1 352 threshold voltage. For example, if the input or output signals on the I/O pad 341 have a maximum voltage level of 3.3V under normal operating conditions, the diode string 349 should be designed with 8-stacked diodes. The diodes have a cut-in voltage of around 0.5V in general CMOS processes, and therefore the diode string 349 with 8-stacked diodes has a voltage-blocking level of about 4V. This means that the P-STSCR device 344 is triggered on only when the voltage level on the pad is higher than 4V. By adjusting the number of stacked diodes in the diode string 349 and in the diode string 369, the positive and the negative voltage level on the I/O pad 341 to trigger on the P-STSCR 344 and the N-STSCR 364 device can be correctly designed to meet different applications with different signal voltage levels.

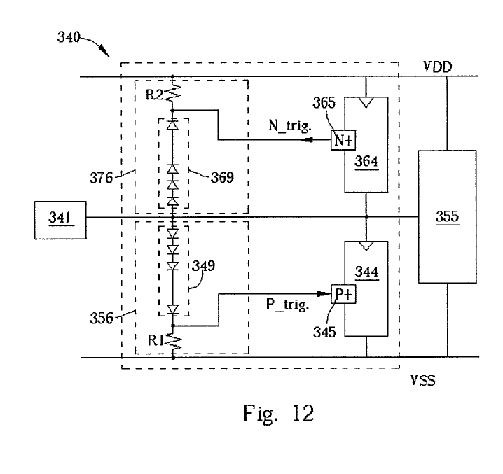

Please refer to FIG. 12. FIG. 12 is a schematic diagram of using a P-STSCR device 344 and an N-STSCR device 364 in an ESD protection circuit 340 for an I/O pad 341 according to the present invention. A diode string under forward biased conditions often has a high driving current. The NMOS transistor Mn1 352 and the PMOS transistor Mp1 372 in FIG. 11 can thus be removed to further save silicon area. As shown in FIG. 12, when a positive-to-V_{SS} ESD event occurs on the I/O pad 341, some of the positive ESD current is conducted into the P-trigger node 345 through the diode string 349 to turn on the P-STSCR device 344 to discharge the ESD current from the I/O pad 341 to the V_{SS} power terminal. When a negative-to-V_{DD} ESD event occurs on the I/O pad 341, some of the negative ESD current is conducted into the N-trigger node 365 through the diode string 369 to turn on the N-STSCR device 364 to discharge the ESD current from the I/O pad 341 to the grounded V_{DD} power terminal.

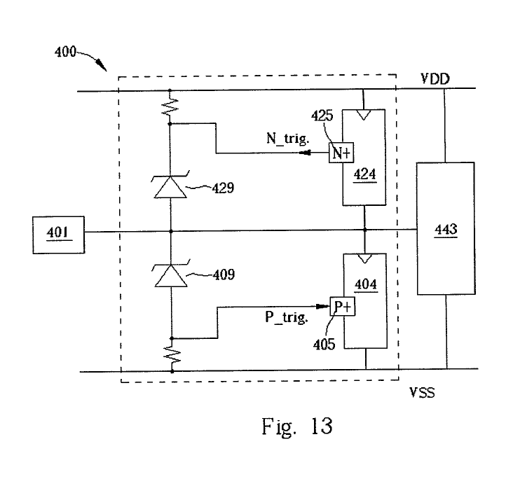

Please refer to FIG. 13. FIG. 13 is a schematic diagram of using a P-STSCR device 404 and an N-STSCR device 424 in an ESD protection circuit 400 for an I/O pad 401 according to the present invention. As shown in FIG. 13, the diode strings 349,369 in the ESD-detection circuits 356, 376 in FIG. 12 are replaced with two zener diodes 409,429. The zener diodes 409,429 are designed to have a breakdown voltage greater than the normal signal voltage level on the I/O pad 401. Under normal operating conditions, a normal signal voltage level on the I/O pad 401 does not cause breakdown of the zener diodes 409,429. Therefore, the P-STSCR 404 and N-STSCR 424 devices are kept turned off under normal IC operating conditions. But under an ESD event, the positive or negative ESD voltage causes breakdown of the zener diode 409,429 to generate the trigger current into the P-trigger node 405 or N-trigger node 425 of the P-STSCR 404 or N-STSCR 424 device to turn on the P-STSCR 404 or N-STSCR 424 device so that the internal circuit 443 is protected.

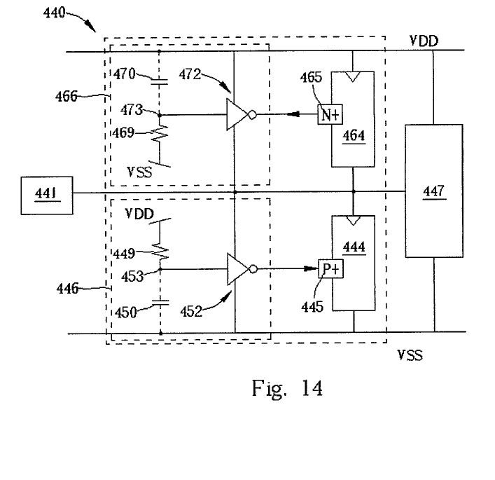

Please refer to FIG. 14. FIG. 14 is a schematic diagram of using a P-STSCR device 444 and an N-STSCR device 464 in an ESD protection circuit 440 for an I/O pad 441 according to the present invention. As shown in FIG. 14, the ESD-detection circuit 446, used to trigger the P-STSCR 444, comprises a resistor 449, a capacitor 450 and an inverter (INV-1) 452, and is designed with the resistor 449 electrically connected from the V_{DD} power terminal to the input node 453 of the inverter INV_1 452. The input node 453 of the INV_1 452 to the V_{SS} power terminal may have a capacitor 450. The capacitor 450 can be a parasitic capacitor of the inverter INV_1 452 or a real capacitor. Under normal IC operating conditions with V_{SS} and V_{DD} supplies, the input node 453 of INV_1 452 is kept at V_{DD} by the resistor 449. Therefore, the output of INV_1 452 is kept at V_{SS}. The P-trigger node 445 of the P-STSCR device 444 is biased at V_{SS} by the output of INV_1 452, so the P-STSCR device 444 is kept off under normal IC operating conditions. When a positive-to-V_{SS} ESD event occurs on the I/O pad 441, the input of INV_1 452 is initially kept at zero by the capacitor 450, and the INV_1 452 is biased by the ESD energy on the I/O pad 441. Therefore, the output of INV_1 452 is charged up to high by the ESD energy to generate the trigger current into the P-trigger node 445 of the P-STSCR device 444. Finally, the P-STSCR device 444 is turned on by the trigger current generated from the INV_1 452 output, and the ESD current is discharged from the I/O pad 441 to the V_{SS} power terminal through the P-STSCR device 444. A similar but reverse circuit operation also applies to the resistor 469, the capacitor 470 and the inverter INV_2 472 to turn on the N-STSCR device 464 under negative-to-V_{DD} ESD events, but which keep the N-STSCR device 464 turned off under normal IC operating conditions.

Some normal IC application conditions involve high noise pulses, such as motor control ICs or military-application ICs. Under such conditions, the P-STSCR or N-STSCR devices in the input/output ESD protection circuits may be triggered on by overshooting or undershooting noise pulses. If the P-STSCR or N-STSCR devices in the ESD protection circuit are triggered on by noise pulses, the voltage level on the I/O pad will be clamped to the voltage level around the holding voltage of the lateral SCR device (usually about 1V in non-epitaxial wafers). This will cause an incorrect voltage level on the input or output signals, and cause operating errors in the IC or systems.

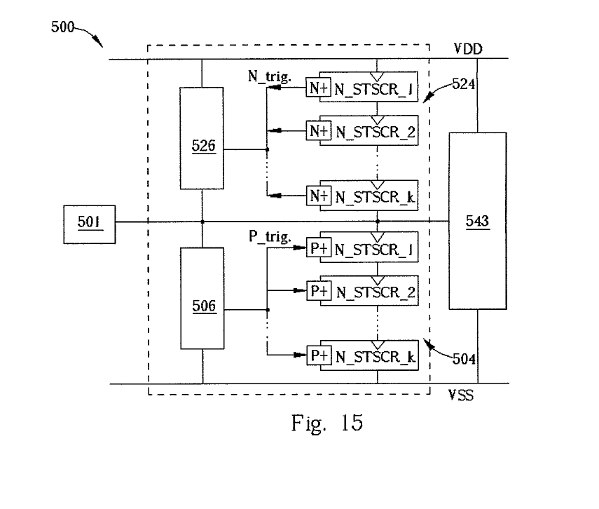

In order to avoid this unwanted triggering of the ESD-protection P-STSCR or N-STSCR devices for an IC operating in a noisy environment, a second embodiment of the present invention is proposed having an alternative design. Please refer to FIG. 15. FIG. 15 is a schematic diagram of the basic concept of using stacked P-STSCR 504 devices and stacked N-STSCR 524 devices in an ESD protection circuit 500 for an I/O pad 501 according to the second embodiment of the present invention. As shown in FIG. 15, with stacked P-STSCR 504 and stacked N-STSCR 524 devices in the ESD protection circuit 500, the total holding voltage of the stacked P-STSCR 504 devices or the stacked N-STSCR 524 devices is designed to be greater than a V_{DD} voltage level of the IC, or the maximum voltage level of normal signals on the I/O pad 501. As shown in FIG. 15, the ESD protection circuit 500 further comprises two ESD-detection circuits 506 and 526. For example, in 3.3V IC applications, the stacked P-STSCR 504 devices or the stacked N-STSCR 524 devices in the ESD protection circuit 500 are designed as 4-stacked STSCR devices. With 4-stacked STSCR devices in the stacked P-STSCR 504 devices and the stacked N-STSCR 524 devices, the total holding voltage of both the stacked P-STSCR 504 and the stacked N-STSCR 524 devices is about 4V, which is greater than the maximum voltage level of normal signals on the I/O pad 501. With a total holding voltage greater than V_{DD} or the maximum voltage level of signals on the I/O pad 501, even if some SCR devices in the stacked P-STSCR 504 or the stacked N-STSCR 524 devices in the ESD protection circuit are triggered on by noise pulses, the unexpected turning on of the SCR devices in the stacked P-STSCR 504 or the stacked N-STSCR 524 devices does not interfere the normal circuit operation of the I/O circuit 543 in the IC.

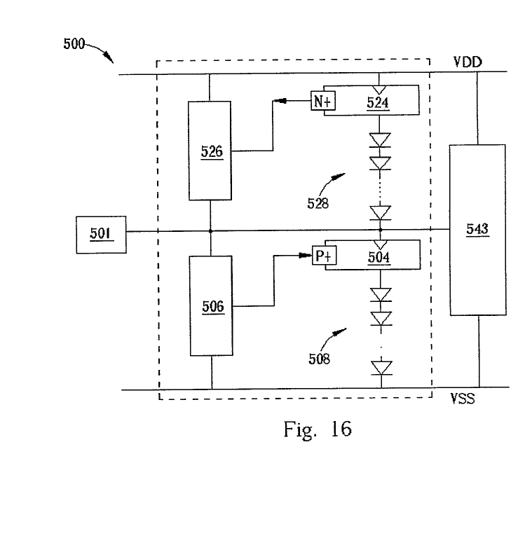

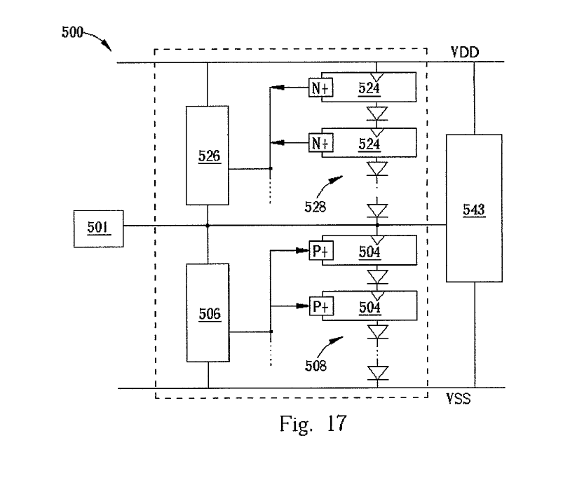

FIG. 16 is a schematic diagram of using P-STSCR device 504 with serier-connected stacked diodes 508 and N-STSCR device 524 with serier-connected stacked diodes 528 in an ESD protection circuit 500 for an I/O pad 501 according to the second embodiment of the present invention. FIG. 17 is a schematic diagram of using stacked P-STSCR 504 devices, stacked N-STSCR 524 devices, stacked diodes 508, and stacked diodes 528 in an ESD protection circuit 500 for an I/O pad 501 according to the second embodiment of the present invention. As shown in FIG. 16, two sets of stacked diodes 508, 528 are used to increase the total holding voltage of the P-STSCR 504 and N-STSCR 524 devices. As shown in FIG. 17, by using a combination of both stacked P-STSCR 504 devices and stacked diodes 508, or stacked N-STSCR 524 devices and stacked diodes 528, the total holding voltage for the P-STSCR 504 or N-STSCR 524 devices in the ESD protection circuit is increased. In FIG. 15 to FIG. 17, the ESD-detection circuits 506 and 526 can be realized as designed and shown in FIG. 9 to FIG. 14.

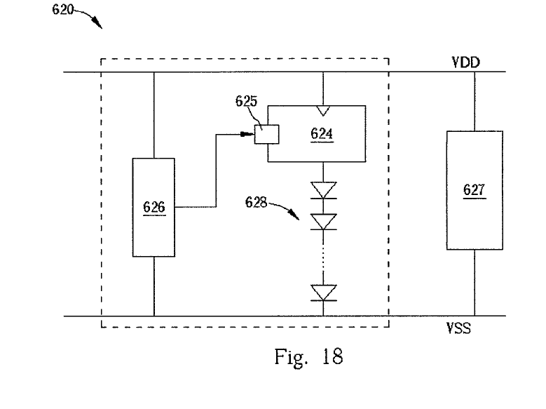

The P-STSCR and N-STSCR devices can be also applied in the design of power-rail ESD clamp circuits. Please refer to FIG. 18. FIG. 18 is a schematic diagram of using a P-STSCR 624 with stacked diodes 628 as an ESD clamp device between V_{SS} and V_{DD} power rails according to the third embodiment of present invention. When a positive ESD event occurs across the V_{DD} and V_{SS} power rails, the ESD-detection circuit 626 is designed to conduct a trigger current into the P-trigger node 625 of the P-STSCR device 624. Therefore, the P-STSCR device 624 is triggered on to discharge ESD current from the V_{DD} power terminal to the V_{SS} power terminal through the turned-on P-STSCR device 624 and the stacked diodes 628. The total holding voltage level of the P-STSCR device 624 with the stacked diodes 628 in its turned-on condition should be greater than the maximum V_{DD} voltage to avoid latch-up issues in the power-rail protection circuit.

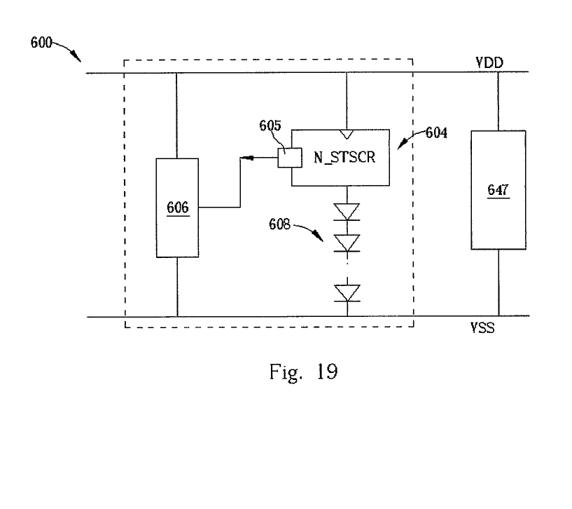

Please refer to FIG. 19. FIG. 19 is a schematic diagram of using an N-STSCR 604 with stacked diodes 608 as an ESD clamp device between V_{DD} and V_{SS} power rails according to a third embodiment of the present invention. When a positive overstress ESD event occurs across the V_{DD} and V_{SS} power rails, the ESD-detection circuit 606 is designed to conduct a trigger current from the N-trigger node 605 of the N-STSCR device 604. Therefore, the N-STSCR device 604 is triggered on to discharge ESD current through an extremely low resistance path from the V_{DD} power terminal to the V_{SS} power terminal by turning on the N-STSCR device 604 and the stacked diodes 608. The number of stacked diodes 608 in the power-rail ESD clamp circuit is dependent on the V_{DD} voltage level of the IC under normal operating conditions. The total holding voltage level of the N-STSCR device 604 with the stacked diodes 608 in its turned-on condition should be greater than the maximum V_{DD} voltage to avoid latch-up issues in the power-rail protection circuit.

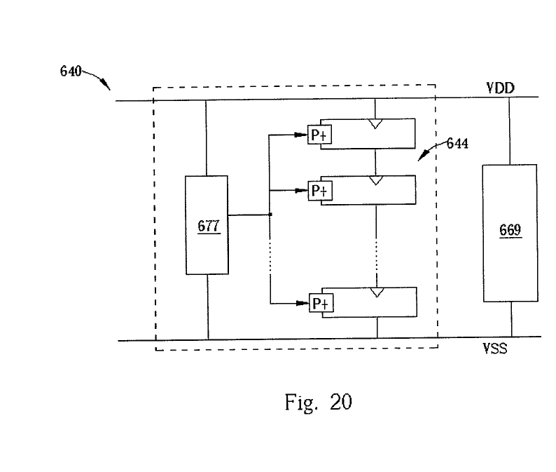

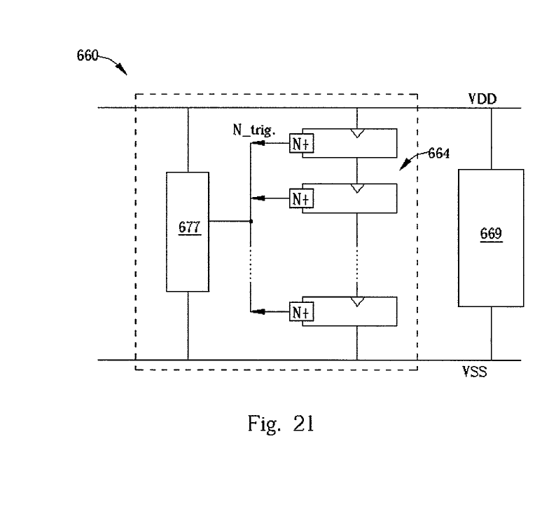

For the same circuit functionality, some alternative designs are proposed. Please refer to FIG. 20 to FIG. 21. FIG. 20 is a schematic diagram of using stacked P-STSCR devices 644 in a power-rail ESD clamp circuit 640 according to the third embodiment of present invention. FIG. 21 is a schematic diagram of using stacked N-STSCR devices 664 in a power-rail ESD clamp circuit 660 according to the third embodiment of present invention. As shown in FIG. 20 and FIG. 21, both the ESD protection circuits 640 and 660 comprise an ESD-detection circuit 677, and an internal circuit 669 is electrically connected between each pair of power-rails.

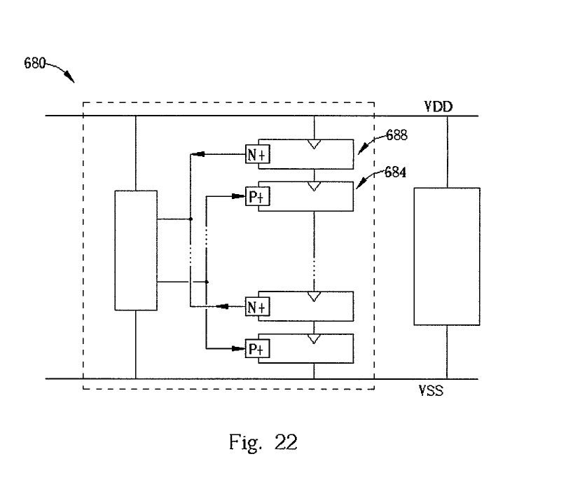

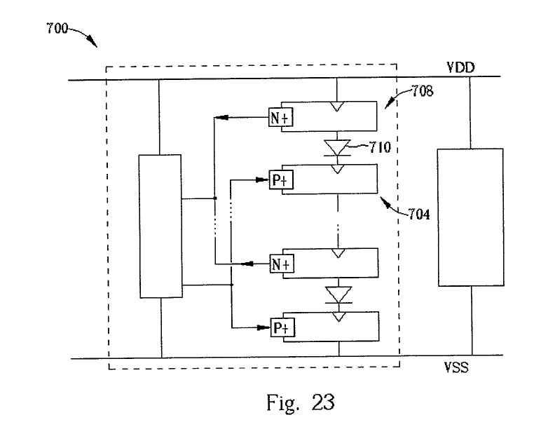

Please refer to FIG. 22 and FIG. 23. FIG. 22 is a schematic diagram of using stacked P-STSCR 684 devices and stacked N-STSCR 688 devices in a power-rail ESD clamp circuit 680 according to the third embodiment of present invention. FIG. 23 is a schematic diagram of a combined design using stacked P-STSCR devices 704, stacked N-STSCR 708 devices, and diodes 710 in a power-rail ESD clamp circuit 700 according to the third embodiment of present invention. As shown in FIG. 22 and FIG. 23, both the ESD protection circuits 680 and 700 have different ESD-detection circuit design when compared with the ESD-detection circuit 677 in FIG. 20 and FIG. 21. However, the same STSCR devices, such as stacked P-STSCR devices, stacked N-STSCR devices, are utilized as triggering devices.

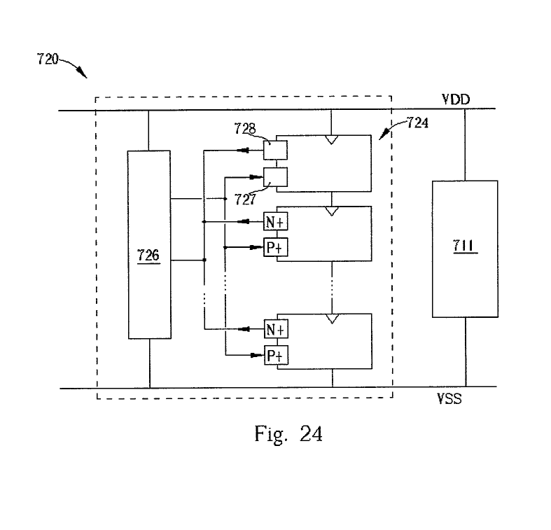

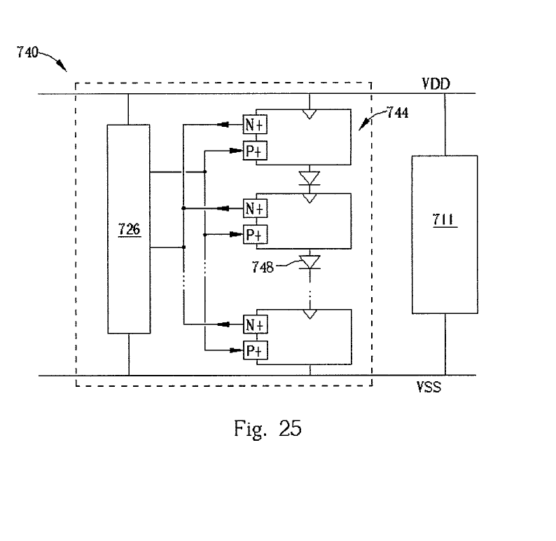

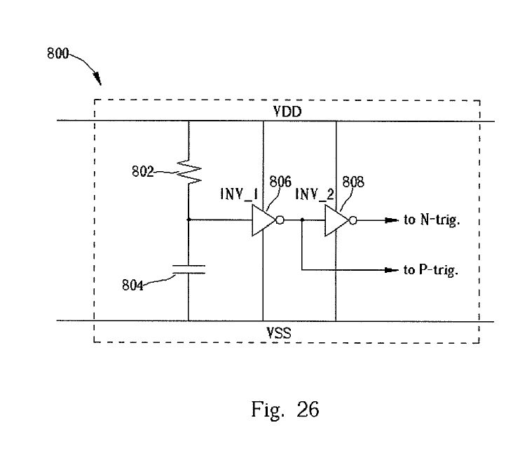

Please refer to FIG. 24 and FIG. 25. FIG. 24 is a schematic diagram of using double-triggered SCR (DT-SCR) devices 724 in a power-rail ESD clamp circuit 720 according to the third embodiment of present invention. FIG. 25 is a schematic diagram of using DT-SCR devices 744 and diodes 748 in a power-rail ESD clamp circuit 740 according to the third embodiment of present invention. To turn on the double-triggered SCR devices 724 for protecting an internal circuit 711, the ESD-detection circuit 726 is designed to generate both of the trigger currents to the P-trigger nodes 727 and the N-trigger nodes 728 of the DT-SCR devices 724. The detailed circuit design to form the suitable ESD-detection circuit 726 is shown later in FIG. 26 to FIG. 30. Of course, the devices used in a stacked configuration between V_{DD} and V_{SS} power rails may be designed as a combination of P-STSCR devices, N-STSCR devices, DT-SCR devices, or diodes. In principle, the total blocking voltage of a stacked configuration using P-STSCR, N-STSCR or DT-SCR devices, or using diodes, between the V_{DD} and V_{SS} power rails, should be designed to be greater than a maximum voltage level of V_{DD} under normal IC operating conditions to avoid latch-up issues.

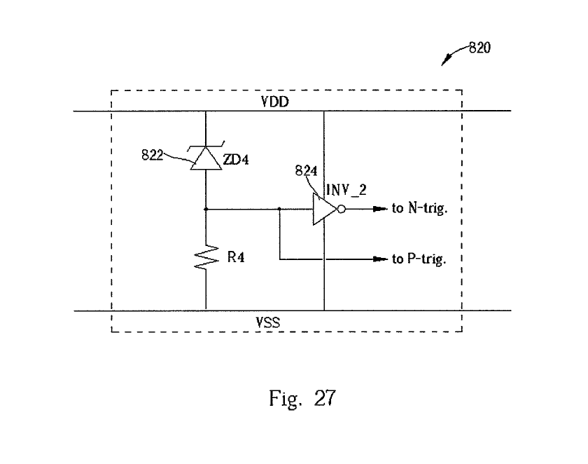

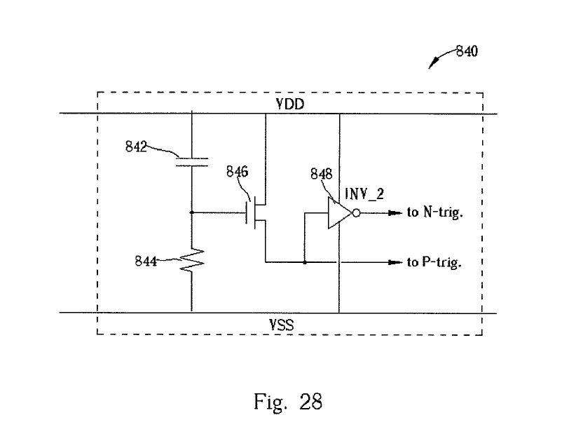

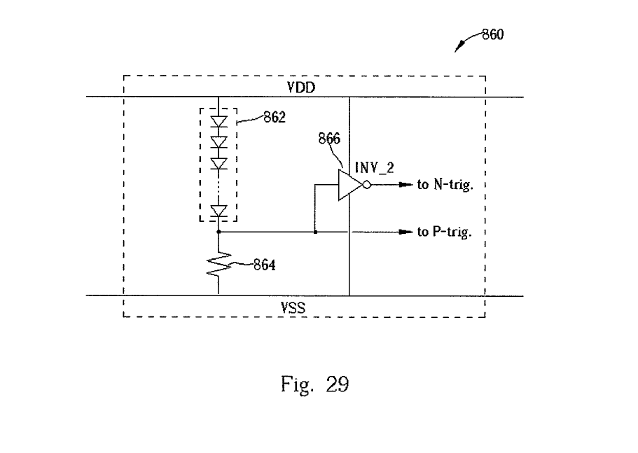

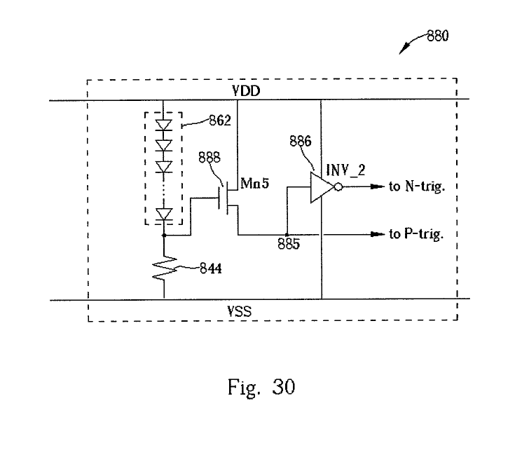

Please refer to FIG. 26 to FIG. 30. FIG. 26 to FIG. 30 are schematic diagrams of ESD-detection circuits 800,820,840,860,880 used to control turning-on and turning-off of stacked configurations between V_{DD} and V_{SS} power rails according to the present invention. In FIG. 26, a resistor 802 and capacitor 804 are designed to have a RC constant of around 0.1˜1 μs, which can therefore detect an ESD event having a rise time of approximately 10 ns. The output of INV_1 806 is connected to the P-trigger nodes of P-STSCR devices (not shown) or DT-SCR devices (not shown). The output of INV_2 808 is connected to the N-trigger nodes of N-STSCR devices (not shown) or DT-SCR devices (not shown). In FIG. 27, a zener diode 822 is used to detect an ESD event. When a voltage level across V_{DD} and V_{SS} power rails is greater than the breakdown voltage of the zener diode 822, the zener diode 822 breaks down and generates a trigger current, which is connected to P-trigger nodes of P-STSCR devices (not shown) or DT-SCR devices (not shown). The output of INV_2 824 is connected to N-trigger nodes of N-STSCR devices (not shown) or DT-SCR devices (not shown). In FIG. 28, an ESD-detection circuit 840 is formed using a gate-coupled design with a capacitor 842, a resistor 844, and an NMOS transistor 846 to enhance the trigger current for P-trigger nodes of P-STSCR devices (not shown) or DT-SCR devices (not shown). The output of the INV_2 848 is connected to N-trigger nodes of N-STSCR devices (not shown) or DT-SCR devices (not shown). In FIG. 29, the ESD-detection circuit 860 is formed by a diode string 862 and a resistor 864. The trigger current, which is connected to P-trigger nodes of P-STSCR devices (not shown) or DT-SCR devices (not shown), is generated by an overstress ESD current flowing through the diode string 862 under an ESD event. The output of INV_2 866 is connected to N-trigger nodes of N-STSCR devices (not shown) or DT-SCR devices (not shown). In FIG. 30, an NMOS transistor Mn5 888 is added to enhance the trigger current connecting to P-trigger nodes of P-STSCR devices (not shown) or DT-SCR devices (not shown) under an ESD event. The output of INV_2 886 is connected to N-trigger nodes of N-STSCR devices (not shown) or DT-SCR devices (not shown). By using the above-mentioned ESD-detection circuits, devices in stacked configurations between V_{DD} and V_{SS} power rails can be triggered on during ESD events, and kept off during normal IC operating conditions.

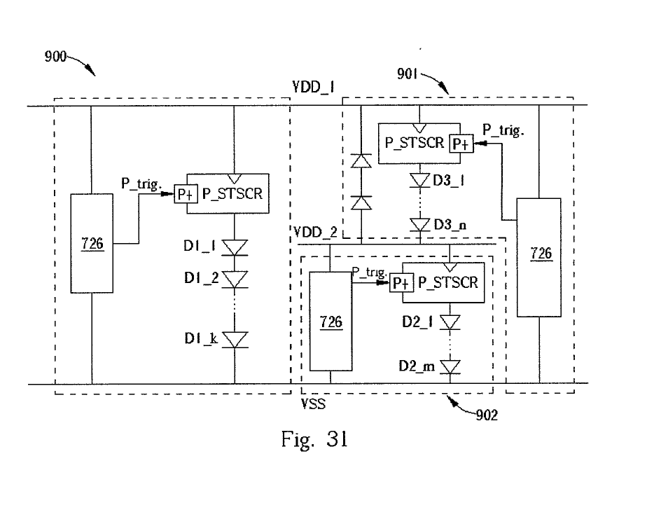

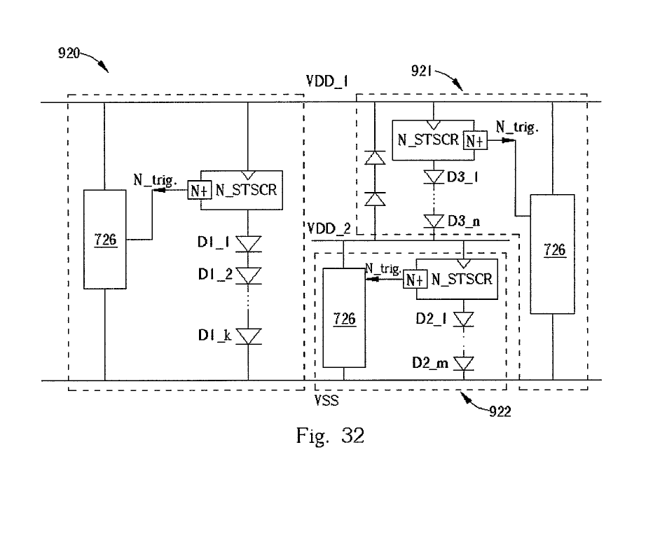

With more circuits and functionality being integrated into a single chip, such as in system-on-chip designs, a CMOS IC may have different V_{DD} power supplies. In this case, ESD clamp circuits for different power rails, using the proposed P-STSCR, N-STSCR, DT-SCR or diodes in stacked configurations, are proposed. Please refer to FIG. 31 to FIG. 32. FIG. 31 to FIG. 32 are schematic diagrams of using the present invention devices in power-rail ESD clamp circuits 900, 920 having different V_{DD}power supplies. In FIG. 31 and FIG. 32, when an ESD voltage is across V_{DD}1 and V_{SS}, across V_{DD}2 and V_{SS}, or across V_{DD}1 and V_{DD}2 power rails, an ESD clamp circuit connected between the power rails (V_{DD}1, V_{DD}2 and V_{SS}) is turned on to discharge the ESD current to the relatively grounded pin. The ESD clamp circuits 900, 901, 902, 920, 921, 922 designs in FIG. 31 and FIG. 32 have been demonstrated as the ESD clamp circuits 600, 620, 640, 660, 680, 700, 720, 740 in FIG. 18 to FIG. 25. In FIG. 31, the total holding voltage level of the triggering devices in the ESD clamp circuits 900, 901, 902, which are determined by the voltage level of V_{DD}1, V_{DD}2 and V_{SS}, are different to each other. Similarly, the total holding voltage level of the triggering devices in the ESD clamp circuits 920, 921, 922 in FIG. 32 are different to each other. Actually, the power-rail ESD clamp circuit may have a plurality of V_{DD} power supplies (V_{DD}1, V_{DD}2, . . . V_{DD}n) and one corresponding ESD clamp circuit, connected between two power rails, is turned on to discharge the ESD current to the relatively grounded pin when an ESD voltage is across the two power rails.

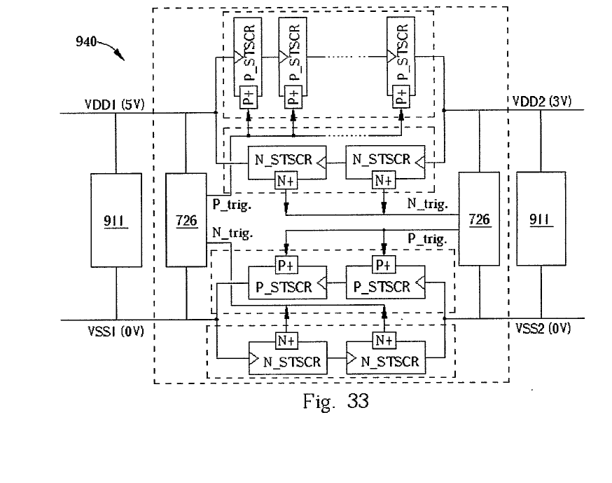

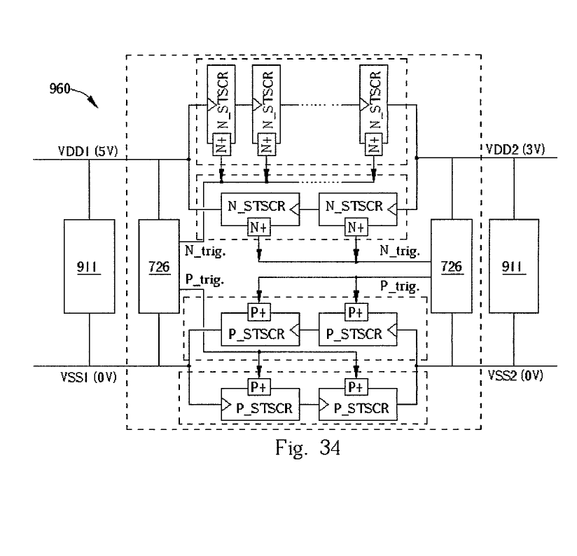

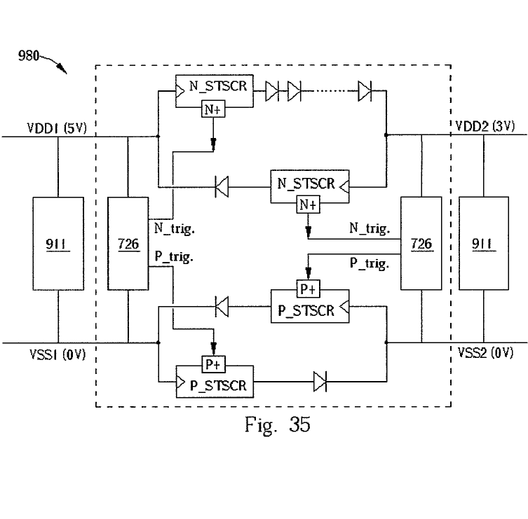

Please refer to FIG. 33 to FIG. 35. FIG. 33 to FIG. 35 are schematic diagrams of using a present invention device in a power-rail ESD clamp circuit 940, 960, 980 with different V_{DD} and V_{SS} power rails. As shown in FIG. 33 to FIG. 35, the proposed P-STSCR, N-STSCR, DT-SCR or diodes, in a stacked configuration, may also be applied in the ESD-connection circuits between the separated power rails. The design principle is to turn off the P-STSCR, the N-STSCR, the DT-SCR or the diodes in the stacked configuration when the IC is operating under normal operating conditions, and to turn on the P-STSCR, the N-STSCR, the DT-SCR, or the diodes in the stacked configuration when the IC is under an ESD event to protect core circuit 911. Such a design principle can be achieved by using the proper ESD-detection circuits to control the P-trigger and N-trigger nodes in the P-STSCR, the N-STSCR, or the DT-SCR devices. Suitable ESD-detection circuits that correctly control the turning-on or turning-off of the ESD-connection circuits between the separated power rails have been demonstrated in FIG. 26 to FIG. 30. And a single ESD-detection circuit 726 is collectively used by separated power rails. The ESD-detection circuits 726 and the triggering devices form the ESD clamp circuits 600, 620, 640, 660, 680, 700, 720, 740 which have been demonstrated in FIG. 18 to FIG. 25.

In summary, the method for forming an on-chip ESD protection circuit according to the present invention involves using a substrate-triggered SCR device in the protection circuit, and applying the substrate-triggered SCR device to an input ESD protection circuit, an output ESD protection circuit, or a power-rail ESD clamp circuit. Therefore, not only is the ESD robustness of the IC product in the deep submicron CMOS IC improved, but also the total layout area of the on-chip ESD protection circuit is also reduced.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electrostatic discharge (ESD) protection circuit electrically connected to an input/output (I/O) buffering pad, an internal circuit, a V_{SS} power terminal, and a V_{DD} power terminal, the ESD protection circuit comprising:
a first ESD-detection circuit electrically connected between the I/O buffering pad and the V_{SS} power terminal;
a P-type substrate-triggered silicon controlled rectifier (P-STSCR) comprising a first lateral silicon controlled rectifier (SCR) and a P-type trigger node, an anode and a cathode of the P-STSCR being electrically connected to the I/O buffering pad and the V_{SS} power terminal respectively;
a second ESD-detection circuit electrically connected between the I/O buffering pad and the V_{DD} power terminal; and
an N-type substrate-triggered silicon controlled rectifier (N-STSCR) comprising a second lateral SCR and an N-type trigger node, a cathode and an anode of the N-STSCR being electrically connected to the I/O buffering pad and the V_{DD} power terminal respectively.

2. The ESD protection circuit of claim 1 wherein the P-STSCR further comprises:
a P-type substrate;
an N-well in the P-type substrate;
a first N⁺ diffusion region and a first P⁺ diffusion region in P-type substrate for use as the cathode of the P-STSCR; and
a second N⁺ diffusion region and a second P⁺ diffusion region in the N-well for use as the anode of the P-STSCR, the second P⁺ diffusion region, the N-well, the P-type substrate and the first N⁺ diffusion region forming the first lateral SCR.

3. The ESD protection circuit of claim 2 wherein when a positive voltage pulse is applied to the I/O buffering pad, the first ESD detection circuit produces a first trigger current flowing into the P-type trigger node of the P-STSCR to trigger the first lateral SCR in the P-STSCR to enter a latch state, the latch state quickly turning on the P-STSCR so that a current incurred from the positive voltage pulse is discharged to the V_{SS} power terminal.

4. The ESD protection circuit of claim 1 wherein the N-STSCR in the ESD protection circuit further comprises:
a P-type substrate;
an N-well in the P-type substrate;
a first N⁺ diffusion region and a first P⁺ diffusion region in P-type substrate for use as the cathode of the N-STSCR; and
a second N⁺ diffusion region and a second P⁺ diffusion region in the N-well for use as the anode of the N-STSCR, the second P⁺ diffusion region, the N-well, the P-type substrate and the first N⁺ diffusion region forming the second lateral SCR.

5. The ESD protection circuit of claim 4 wherein when a negative voltage pulse is applied to the I/O buffering pad, the second ESD detection circuit produces a second trigger current that flows into the N-type trigger node of the N-STSCR to trigger the second lateral SCR in the N-STSCR to enter a latch state, the latch state quickly turning on the N-STSCR so that current incurred from the negative voltage pulse is discharged to the V_{DD} power terminal.

6. The ESD protection circuit of claim 1 wherein the first ESD protection circuit comprises a first resistor, a first capacitor, a zener diode, a diode string or an NMOS.

7. The ESD protection circuit of claim 6 wherein the NMOS enhances the first trigger current so as to accelerate the triggering of the P-STSCR.

8. The ESD protection circuit of claim 1 wherein the second ESD detection circuit comprises a second resistor, a second capacitor, a zener diode, a diode string or a PMOS.

9. The ESD protection circuit of claim 8 wherein the PMOS enhances the second trigger current so as to accelerate the triggering of the N-STSCR.

10. ESD protection circuit of claim 1 wherein the fist ESD detection circuit comprises a third resistor, a third capacitor and a first inverter, an input node of the first inverter electrically connected to the V_{DD} power terminal and the V_{SS} power terminal through the third resistor and the third capacitor respectively, an output node of the first inverter electrically connected to the P-type trigger node of the P-STSCR.

11. The ESD protection circuit of claim 10 wherein when a positive ESD voltage pulse is applied to the I/O buffering pad, the first inverter is charged by the positive ESD voltage pulse to generate a third trigger current at the output node of the first inverter, the third trigger current flowing into the P-type trigger node of the P-STSCR to trigger the fist lateral SCR, the first lateral SCR entering a latch state in response to the third trigger current and quickly turning on the P-STSCR so that current incurred from the positive voltage pulse is discharged to the V_{SS} power terminal.

12. The ESD protection circuit of claim 1 wherein the second ESD detection circuit comprises a fourth resistor, a fourth capacitor, and a second inverter, an input node of the second inverter electrically connected to the V_{SS} power terminal and the V_{DD} power terminal through the fourth resistor and the fourth capacitor respectively, an output node of the second inverter electrically connected to the N-type trigger node of the N-STSCR.

13. The ESD protection circuit of claim 12 wherein when a negative ESD voltage pulse is applied to the I/O buffering pad, the output node of the second inverter is charged by the negative ESD voltage pulse to generate a fourth trigger current at the N-type trigger node of the N-STSCR to trigger the second lateral SCR, the second lateral SCR entering a latch state in response to the fourth trigger current to turn on the N-STSCR quickly so that current incurred from the negative voltage pulse is discharged to the V_{DD} power terminal.

14. An electrostatic discharge (ESD) protection circuit electrically connected to an I/O buffering pad, an internal circuit, a V_{SS} power terminal and a V_{DD} power terminal, the ESD protection circuit comprising:
a first ESD-detection circuit electrically connected between the I/O buffering pad and the V_{SS} power terminal;
a first stacked silicon controlled rectifier (SCR) electrically connected between the V_{SS} power terminal and the I/O buffering pad, the first stacked SCR series connected by a plurality of P-type substrate-triggered silicon controlled rectifiers (P-STSCR), each P-STSCR comprising a first lateral SCR and a P-type trigger node;
a second ESD-detection circuit electrically connected between the I/O buffering pad and the V_{DD} power terminal; and
a second stacked SCR electrically connected between the V_{DD} power terminal and the I/O buffering pad, the second stacked SCR series connected by a plurality of N-type substrate-triggered silicon controlled rectifiers (N-STSCR), each N-STSCR comprising a second lateral SCR and an N-type trigger node;
wherein a total holding voltage for the first stacked SCR is greater than a maximum voltage level of a normal signal on the I/O buffering pad, and a total holding voltage for the second stacked SCR is less than a minimum voltage level of the normal signal on the I/O buffering pad, so as to prevent normal signals from being interfered because of the unexpected turn-on of the ESD protection circuit by noise.

15. The ESD protection circuit of claim 14 wherein each P-STSCR further comprises:
a P-type substrate;
an N-well in the P-type substrate;
a first N⁺ diffusion region and a first P⁺ diffusion region in the P-type substrate for use as the cathode of the P-STSCR; and
a second N⁺ diffusion region and a second P⁺ diffusion region in the N-well for use as the anode of the P-STSCR, the second P⁺ diffusion region, the N-well, the P-type substrate and the first N⁺ diffusion region forming the first lateral SCR.

16. The ESD protection circuit of claim 14 wherein the first stacked SCR further comprises a plurality of diodes series connected with each P-STSCR.

17. The ESD protection circuit of claim 14 wherein each N-STSCR further comprises:
a P-type substrate;
an N-well in the P-type substrate;
a first N⁺ diffusion region and a first P⁺ diffusion region in the P-type substrate for use as the cathode of the N-STSCR; and
a second N⁺ diffusion region and a second P⁺ diffusion region in the N-well for use as the anode of the N-STSCR, the second P⁺ diffusion region, the N-well, the P-type substrate and the first N⁺ diffusion region forming the second lateral SCR.

18. The ESD protection circuit of claim 14 wherein the second stacked SCR further comprises a plurality of diodes series connected with each N-STSCR.

19. A power-rail electrostatic discharge (ESD) clamp circuit electrically connected between a V_{SS} power terminal and a V_{DD} power terminal, the power-rail ESD clamp circuit comprising:
an ESD-detection circuit electrically connected between the V_{SS} power terminal and the V_{DD} power terminal;
at least one substrate-triggered silicon controlled rectifier (STSCR), the STSCR comprising a lateral silicon controlled rectifier (SCR) and at least one trigger node, an anode and a cathode of the STSCR electrically connected to the V_{DD} power terminal and the V_{SS} power terminal.

20. The power-rail ESD clamp circuit of claim 19 wherein the STSCR is a P-type substrate-triggered silicon controlled rectifier (P-STSCR) and the trigger node is a P-type trigger node.

21. The power-rail ESD clamp circuit of claim 20 wherein when a positive ESD voltage pulse is applied across the V_{DD} power terminal and the V_{SS} power terminal, the ESD detection circuit generates a trigger current that flows into the P-type trigger node of the P-STSCR to trigger the lateral SCR in the P-STSCR so that the lateral SCR enters a latch state and quickly turns on the P-STSCR to discharge current incurred from the positive ESD voltage pulse.

22. The power-rail ESD clamp circuit of claim 19 wherein the substrate-triggered silicon controlled rectifier is an N-type substrate-triggered silicon controlled rectifier (N-STSCR) and the trigger node is an N-type trigger node.

23. The power-rail ESD clamp circuits of claim 22 wherein when a positive ESD voltage pulse is applied across the V_{DD} power terminal and the V_{SS} power terminal, the ESD detection circuits generates a trigger current to trigger the lateral SCR in the N-STSCR so that the lateral SCR enters a latch state and turns on the N-STSCR to quickly discharge current incurred from the positive ESD voltage pulse.

24. The power-rail ESD clamp circuit of claim 19 wherein a plurality of diodes are series connected with the STSCR.

25. The ESD protection circuit of claim 19 wherein the substrate-triggered silicon controlled rectifier (STSCR) is a double-triggered silicon controlled rectifier (DTSCR) and the DT-SCR comprises a P-type trigger node and an N-type trigger node.

26. The power-rail ESD clamp circuit of claim 25 wherein the ESD detection circuit comprises:
a resistor electrically connected to the V_{DD} power terminal;
a capacitor electrically connected to the V_{SS} power terminal; and
a first inverter and a second inverter both electrically connected to the V_{DD} power terminal and the V_{SS} power terminal;
wherein when an ESD voltage pulse is applied across the V_{DD} power terminal and the V_{SS} power terminal, the resistor and the capacitor couple a first voltage to an input node of the first inverter so that a second voltage is output from an output node of the first inverter to the P-type trigger node of the DT-SCR and an input node of the second inverter, and causes a third voltage to be output from the output node of the second inverter to the N-type trigger node of the DT-SCR.

27. The power-rail ESD clamp circuit of claim 25 wherein the ESD detection circuit comprises:
a first electrical device electrically connected to the V_{DD} power terminal;
a second electrical device electrically connected to the V_{SS} power terminal; and
an inverter electrically connected to the V_{DD} power terminal and the V_{SS} power terminal;
wherein when an ESD voltage pulse is applied across the V_{DD} power terminal and the V_{SS} power terminal, the first electrical device and the second electrical device couple a first voltage to the P-type trigger node of the DT-SCR and an input node of the inverter, and causes a second voltage to be output from an output node of the inverter to the N-type trigger node of the DT-SCR.

28. The power-rail ESD clamp circuit of claim 27 wherein the first electrical device a zener diode and the second electrical device is a resistor.

29. The power-rail ESD clamp circuit of claim 27 wherein the first electrical device a diode string and the second electrical device is a resistor.

30. The power-rail ESD clamp circuit of claim 25 wherein the ESD detection circuit comprises:
a first electrical device electrically connected to the V_{DD} power terminal;
a second electrical device electrically connected to the V_{SS} power terminal;
an inverter electrically connected to the V_{DD} power terminal and the V_{SS} power terminal; and
an NMOS transistor electrically connected to the V_{DD} power terminal;
wherein when an ESD voltage pulse is applied across the V_{SS} power terminal and the V_{DD} power terminal, the first electrical device and the second electrical device couple a first voltage to turn on the NMOS transistor so that the NMOS transistor applies a second voltage to the P-type trigger node of the DT-SCR and an input node of the inverter, and causes a third voltage to be output from an output node of the inverter to the N-type trigger node of the DT-SCR.

31. The power-rail ESD clamp circuit of claim 30 wherein the first electrical device a capacitor and the second electrical device is a resistor.

32. The power-rail ESD clamp circuit of claim 30 wherein the first electrical device a diode string and the second electrical device is a resistor.

33. The power-rail ESD clamp circuit of claim 19 wherein an internal circuit is electrically connected between the V_{SS} power terminal and the V_{DD} power terminal.

34. A power-rail ESD clamp circuit for use with mixed voltages, the power-rail ESD clamp circuit being electrically connected between a V_{SS} power terminal and a V_{DD} power terminal, the power-rail ESD clamp circuit comprising a plurality of sub power-rail ESD clamp circuits.

35. The power-rail ESD clamp circuit of claim 34 wherein each of the sub power-rail ESD clamp circuits further comprises:
an ESD-detection circuit; and
at least one substrate-triggered silicon controlled rectifier (STSCR), the STSCR comprising a lateral silicon controlled rectifier (SCR) and at least one trigger node.

36. The power-rail ESD clamp circuit of claim 35 wherein the STSCR is a P-type substrate-triggered silicon controlled rectifier (P-STSCR) and the trigger node is a P-type trigger node.

37. The power-rail ESD clamp circuit of claim 35 wherein the substrate-triggered silicon controlled rectifier is an N-type substrate-triggered silicon controlled rectifier (N-STSCR) and the trigger node is an N-type trigger node.

38. The power-rail ESD clamp circuit of claim 35 wherein the substrate-triggered silicon controlled rectifier (STSCR) is a double-triggered silicon controlled rectifier (DT-SCR) and the DT-SCR comprises a P-type trigger node and an N-type trigger node.

39. The power-rail ESD clamp circuit of claim 35 wherein a plurality of diodes are series connected with the STSCR.

40. The power-rail ESD clamp circuit of claim 34 wherein the V_{DD} power terminal further comprises a first V_{DD} power terminal and a second V_{DD} power terminal, the power-rail ESD clamp circuit comprises a first sub power-rail ESD clamp circuit, a second sub power-rail ESD clamp circuit and a third sub power-rail ESD clamp circuit.

41. The power-rail ESD clamp circuit of claim 40 wherein the first sub power-rail ESD clamp circuit is electrically connected between the first V_{DD} power terminal and the V_{SS} power terminal.

42. The power-rail ESD clamp circuit of claim 40 wherein the second sub power-rail ESD clamp circuit is electrically connected between the first V_{DD} power terminal and the second V_{DD} power terminal.

43. The power-rail ESD clamp circuit of claim 40 wherein the third sub power-rail ESD clamp circuit is electrically connected between the second V_{DD} power terminal and the V_{SS} power terminal.

44. An ESD-connection circuit for use in separated power rails, the separated power rails comprising a first V_{SS} power terminal, a first V_{DD} power terminal, a second V_{SS} power terminal, and a second V_{DD} power terminal, a first core circuit connected between the first V_{DD} power terminal and the first V_{SS} power terminal, a second core circuit connected between the second V_{DD} power terminal and the second V_{SS} power terminal, the ESD-connection circuit comprising:
at least one ESD-detection circuit;
a first sub ESD-connection circuit;
a second sub ESD-connection circuit;
a third sub ESD-connection circuit; and
a fourth sub ESD-connection circuit.

45. The ESD-connection circuit of claim 44 wherein each of the sub ESD-connection circuits further comprises at least one substrate-triggered silicon controlled rectifier (STSCR), the STSCR comprising a lateral silicon controlled rectifier (SCR) and at least one trigger node.

46. The ESD-connection circuit of claim 45 wherein the STSCR is a P-type substrate-triggered silicon controlled rectifier (P-STSCR) and the trigger node is a P-type trigger node.

47. The ESD-connection circuit of claim 45 wherein the substrate-triggered silicon controlled rectifier is an N-type substrate-triggered silicon controlled rectifier (N-STSCR) and the trigger node is an N-type trigger node.

48. The ESD-connection circuit of claim 45 wherein the substrate-triggered silicon controlled rectifier (STSCR) is a double-triggered silicon controlled rectifier (DT-SCR) and the DT-SCR comprises a P-type trigger node and an N-type trigger node.

49. The ESD-connection circuit of claim 45 wherein a plurality of diodes are series connected with the STSCR.

50. The ESD-connection circuit of claim 45 wherein an anode, a cathode and each trigger node of the first sub ESD-connection circuit are electrically connected to first V_{DD} power terminal, the second V_{DD} power terminal, and the ESD detection circuit, respectively.

51. The ESD-connection circuit of claim 45 wherein an anode, a cathode and each trigger node of the second sub ESD-connection circuit are electrically connected to the second V_{DD} power terminal, the first V_{DD} power terminal, and the ESD detection circuit, respectively.

52. The ESD-connection circuit of claim 45 wherein an anode, a cathode and each trigger node of the third sub ESD-connection circuit are electrically connected to the second V_{SS} power terminal, the first V_{SS} power terminal, and the ESD detection circuit, respectively.

53. The ESD-connection circuit of claim 45 wherein an anode, a cathode and each trigger node of the fourth sub ESD-connection circuit are electrically connected to the first V_{SS} power terminal, the second V_{SS} power terminal, and the ESD detection circuit, respectively.

54. The ESD-connection circuit of claim 44 wherein the ESD-detection circuit is electrically connected between the first V_{DD} power terminal and the first V_{SS} power terminal.

55. The ESD-connection circuit of claim 44 wherein the ESD-detection circuit is electrically connected between the second V_{DD} power terminal and the second V_{SS} power terminal.
